(19) United States
(12) Patent Application Publication
(10) Pub. No.: US 2009/0008588 A1
(43) Pub. Date: Jan. 8, 2009

(54) Shut-Off Device for a Waste-Water Inspection Chamber

(76) Inventor: Klaus Ulrich Giehl, Heimborn (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/887,996

(22) PCT Filed: Apr. 7, 2006
(86) PCT No.: PCT/EP2006/003198

§ 371 Date: Nov. 1, 2007

(30) Foreign Application Priority Data
Apr. 8, 2005 (DE) 10 2005 016 526.5
Jun. 25, 2005 (DE) 10 2005 029 520.7

(51) Int. Cl. F16K 25/00

(52) U.S. Cl. 251/157

(57) ABSTRACT

The invention relates to a shut-off device for a waste-water inspection chamber which has an upwardly open gutter in its interior with an inlet opening and an outlet opening for the waste-water flow, comprising a shut-off member which is arranged in front of the inlet opening, can be pivoted upwardly through the flow force of the waste-water flow and can be held and released by a magnetic catch, with the magnetic catch tightly holding the shut-off member against the inlet open in the shut-off position and releasing it again on a defined water pressure acting on it in the flow direction for the release of the inlet opening.

### BACKGROUND

The invention relates to a shut-off device for a waste-water inspection chamber in accordance with the kind named in the preamble of claim 1 with which both the intrusion of rats and/or also the intrusion of waste-water caused by backup should be prevented, in particular into property drainage systems or into other waste-water sewage systems.

Rats have become a pest in the sewerage systems of settlements. It is not rare for them to intrude into the residential buildings via the property drainage system. As carriers of plagues and spreaders of infection diseases, rats increasingly represent a potential risk for humans.

In addition, sewer networks are subject to hydraulic overload in many towns under heavy rain phenomena, with the water quantities backing up in the sewage system then propagating up to and into the buildings as a so-called backup and resulting in flooding there. To escape a menacing flood wave in the sewer network, the property drainage systems are preferably also sought out by rats as refuges as the highest parts of the sewage system.

Solid deposits are also increasing as a result of the thickening of the waste-water in the property drainage systems with the resource-saving economization in drinking water consumption and separate rainwater drainage. The solids then increasingly attract rats as sources of food and furthermore frequently result in an odor nuisance and in blockages.

To provide protection against an intrusion of rats from the public sewage systems, automatic rat passage barriers are known which work in the flow gutter of waste-water inspection chambers of the property drainage lines. They are shut-off members which are pivotably supported around a horizontal axis in the region of the apex of the pipe in front of the inlet opening and comprise a grating, individual bars or a plate.

So that the shut-off member sets a resistance against the waste-water flow which is as low as possible and thus can be swung open easily, the shut-off member is designed with an inherent weight which is as low as possible and optionally with counterweight support. The disadvantage thereby arises that the shut-off member can be easily raised by the rats due to the low weight.

For protection against backup from the public sewage systems, shut-off devices have become known in inspection chambers of the property drainage system in the form of backup flaps which are arranged in front of the inlet opening analog to the aforesaid functional principle as in the passage barrier for rats. The inlet opening is sealingly closed in this context via the shut-off member in the shut-off position via the pressure of the backflowing water.

In both cases, the theoretical functional process starts from the idea that the shut-off member pivots upwardly in the flow direction under the flow force of the inflowing waste-water for the release of the inlet opening; when the waste-water flow diminishes, the shut-off member pivots downwardly back into the shut-off position via its own weight. The shut-off position also means the bottommost position of the shut-off member directed toward the inlet opening.

The still relatively large waster-water surge triggered for example on the flushing of a toilet equalizes on the flow path in the drainage line and constantly loses flow force up to the end of the drainage event.

The problem arises in this context that the larger solids carried along in the waste-water form deposits with a low water supply, which prevent a complete return of the shut-off member into the shut-off position after the drainage event, due to the relatively low flow force onto the shut-off member or onto the sewer bottom associated therewith. The shut-off member then remains in an open position in an uncontrolled manner, which induces the rats to raise the shut-off member and then to crawl through beneath it.

The same problem also results in the known shut-off devices with equally pivotably supported backup flaps which are intended to secure properties or buildings against backup. If solids also prevent the complete return of the backup flap into the shut-off position in this context, the sealing function against the inflow opening is interrupted and the backup protection is thus ineffective.

It is thus disadvantageous with the known shut-off devices that, on a conventional drainage event, the solid deposits which form as a consequence of too low a flow force result in the aforesaid functional impairments.

A shut-off device of the initially named kind is known from U.S. Pat. No. 5,113,901 in which an electromagnet is additionally used to hold the shut-off member in a completely open position. The shut-off member releases the inflow in this position, but can shut off the inflow in an emergency by deactivating the electromagnet.

### BRIEF SUMMARY

Starting from this, it is the underlying object of the invention to provide such a shut-off device for a waste-water inspection chamber with which the aforesaid disadvantages are avoided and which can be used both as a rat passage barrier and/or as a backup security and for the automatic flushing or cleaning of the sewage line.

The solution of this object takes place in accordance with the characterizing features of claim 1; special further developments are listed in the characterizing features of the dependent claims.

The shut-off device in accordance with claim 1 is provided in accordance with the invention with a magnetic catch which holds the shut-off member sealingly tight against the inlet opening after a drainage event or with a very low drainage flow so that the sporadically inflowing waste-water is collected and dammed in front of the blocking member, seen in the flow direction. With a defined backup goal, the magnetic catch releases via the water pressure, acting on the shut-off member and abruptly releasing the shut-off member, and thus the inlet flow, for the waste-water flow. The retained waste-water now flows off in the manner of a surge, with solid deposits in the region of the shut-off member being swept away as a consequence of the resulting relatively strong flow force and the shut-off device thus being able to function without impediment.

Furthermore, in accordance with the invention, the rats can no longer raise the shut-off member held tightly in the shut-off position by the magnetic catch.

The shut-off device arranged in the interior of a waste-water inspection chamber substantially comprises a shut-off member which is preferably made in flap-form and which, seen against the flow direction, is pivotable in front of the inlet opening around a horizontally arranged stationary axis of rotation in a gutter located between the inlet opening and the outlet opening and upwardly open for the guidance of the waste-water flow.

The magnetic catch, which is preferably arranged at any desired position outside the flow cross-section, comprises the actual magnet as the one part, and an anti-pole reacting to magnetic attractive force as the other part. In this connection, the magnet is advantageously a permanent magnet so that no power connection is required for the operation of the shut-off device. The one part of the magnetic catch is arranged in a stationary manner at the shut-off device and the other part is connected in a motion-matched manner to the shut-off member, with the shut-off member itself also being able to form the anti-pole.

The arrangement of the magnetic catch at the shut-off device can be fixed as desired under design and function aspects, with it being of no importance whether the magnet or the anti-pole is arranged at the shut-off member or is arranged in a stationary manner. An arrangement of the magnetic catch inside the flow cross-section is also conceivable.

In a further advantageous embodiment of the invention, the magnetic catch can be adjusted in its position to vary the closing force.

A seal is advantageously arranged between the front side of the inlet opening and the shut-off member and it is fixedly connected either to the inlet opening and/or to the shut-off member.

In accordance with a preferred embodiment of the invention, the flap-shaped shut-off member, for example, covers the front side of the inlet opening in the shut-off position. In this connection, the magnetic catch pulls the shut-off member sealingly against the inflow opening. The magnetic catch releases the shut-off member abruptly again on a defined water pressure force acting on the shut-off member in the direction of flow.

The shut-off member, which is preferably designed in light construction and is possibly even provided with a float or with a counterweight, is swung upwardly by the waste-water wave occurring in the manner of a surge and is carried by the waste-water wave during the drainage procedure until the flow force diminishes again and the shut-off member moves back to the inflow opening again under its own weight. The attractive force of the magnetic catch is applied again on a corresponding spacing between the shut-off member and the inlet opening, pulls the shut-off member sealingly against the inlet opening again and the cycle starts over.

So that the shut-off member is freely pivotable in front of the inlet opening, the gutter has an increased cross-section in comparison with the inlet opening in the region of the shut-off member.

The interval-like drainage surge adopted in accordance with the invention moreover has the advantage that a hydraulic cleaning effect is also associated herewith for the sewer line located in front of and behind the waste-water inspection chamber. This cleaning effect is brought about by the drainage surge in the inlet passage, above the shut-off device by the drainage ebb and below the shut-off device by the drainage surge.

In accordance with a further embodiment, it is conceivable that the shut-off device can be introduced into the inspection chamber from above, locked to the guide and taken out again by means of a guide, e.g. as a guide rail or similar, attached to the chamber structure for facilitation in maintenance work.

Further advantageously, in accordance with the invention, a resilient outflow stub is arranged for the waste-water flow in the interior of the inlet in front of the shut-off member seen in the flow direction and the solids carried along in the waste-water are held back by said outflow stub in conjunction with the shut-off member in the shut-off phase as with a rake so that said solids cannot penetrate up to the seal and be jammed there.

This increases the operating security of the shut-off member and ensures the function of the magnetic catch since it is prevented that the solids carried along by the waste water are jammed at the seal by the shut-off member.

An upper end, seen in the flow direction, of an outflow stub which is preferably deformable in a manner similar to a bellows is fastened to the wall of the inlet in the interior of the inlet for this purpose. The outflow stub below the fastened point is guided loosely in the inlet so that it is in particular resiliently deformable in the longitudinal direction.

The lower end of the resilient outflow stub, the end of the inlet and the contour of the shut-off member directed toward the outflow stub are associated with one another such that when the water pressure force of the outflowing waste-water onto the shut-off member diminishes and the shut-off member moves toward the shut-off position under its own weight and is finally pressed against the seal, the solids carried along in the waste-water are caught in the outlet opening which is formed between the lower end of the outflow stub and the shut-off member and which is necessarily narrower than the outflow opening formed between the seal and the shut-off member, with said solids thereby being prevented from flowing on into the region of the seal.

The solids held back or jammed in this manner are pushed back by the shut-off member moving toward the shut-off position against the flow direction as a result of the resilience of the outflow stub without a jamming arising at the wall of the inlet which could block the movement of the shut-off member toward the shut-off position.

With a released inlet or with a swung open shut-off member, the resilient outflow stub expands back into its basic shape and the cycle can start over.

Further advantageously, the shut-off member is connected to a pivot arm in a motion-matched manner in that an acceleration member is movable along a guide in a direction perpendicular to the axis of rotation. The acceleration member moves along the guide on the opening and closing of the shut-off member and thus can reinforce or weaken the respective movement of the pivot arm with the shut-off member.

To prevent particularly bulky and lumpy solids from being able to be jammed at the seal between the shut-off member and the gutter bottom by the shut-off member, a further embodiment for the improvement of operating security provides that a rake part, for example in the form of grating rods, a tongue-like sheet metal strip or similar, is arranged in the interior of the inlet, seen in the flow direction, in a defined spacing in front of the shut-off member or of the inlet-opening, said rake part preferably being pivotable in the region of the apex of the pipe and acting in the manner of a forward barrier in the phase of diminishing flow force or with a falling water level in that the solids are caught at the rake part moving in the flow cross-section. It is thereby prevented that the aforesaid solids can move into the region at the seal between the inlet opening and the shut-off member or can move below the closing shut-off member and thus impair the shut-off function.

When the water pressure force acting on the shut-off member in the shut-off position with a retained inflow releases the magnetic catch, the initially relatively strong outflow surge also swings open the rake part in addition to the shut-off member so that the solids last retained by the rake part are flushed away without clogging through the inlet opening by the shut-off member opened relatively wide in this phase.

In accordance with a further development, the rake part can advantageously include a float member so that it is moved upward by a rising water level and thereby again releases the solids previously retained in the lower pre-barrier position for an effective solid removal via the outflow surge. The rake part then first sinks as the water level falls, that is back into the pre-barrier position in a phase critical for the jamming of solids at the shut-off member. The advantage is hereby provided that the energy of the outflow surge is not inhibited directly after release of the inlet opening by a rake part formed, for example, without a float member and acting permanently against the flow and thus the actual pre-barrier function only comes into effect with a diminishing flow force or with a low water level.

The solids initially retained in this manner by the rake in the shut-off phase are then also flushed away in the cycle of the following surge event.

### BRIEF DESCRIPTION OF THE FIGURES

Exemplary embodiments will be explained in more detail in the following with reference to the drawings. There are shown:

FIG. 1: a first embodiment of a shut-off device in a waste-water inspection chamber in the shut-off position as a section in the flow direction;

FIG. 2: a shut-off device in accordance with FIG. 1 as a section transversely to the flow direction seen against the flow direction;

FIG. 3: a shut-off device in accordance with FIG. 1 in a plan view;

FIG. 4: a shut-off device in accordance with FIG. 1 in a waste-water inspection chamber with a released shut-off member as a section in the flow direction;

FIG. 5: a second embodiment of a shut-off device in a waste-water inspection chamber as a section in the flow direction with a released inlet;

FIG. 6: a shut-off device in accordance with FIG. 5 in the shut-off phase;

FIG. 7: a shut-off device in accordance with FIG. 5 in the shut-off position;

FIG. 8: a third embodiment of a shut-off device with a released inlet;

FIG. 9: a shut-off device in accordance with FIG. 6 in the shut-off phase;

FIG. 10: a shut-off device in accordance with FIG. 6 in the shut-off position;

FIG. 11: a fourth embodiment of a shut-off device with a released inlet;

FIG. 12: a shut-off device in accordance with FIG. 11 in the shut-off position;

FIG. 13: a shut-off device in accordance with FIG. 11 in the shut-off position as a section in the flow direction;

FIG. 14: a fifth embodiment of a shut-off device with a released inlet;

FIG. 15: a shut-off device in accordance with FIG. 14 in a sectional view in the flow direction at the level of the rake part;

FIG. 16: a shut-off device in accordance with FIG. 14 in the shut-off position as a section in the flow direction;

FIG. 17: a shut-off device in accordance with FIG. 14 during the flushing process;

FIG. 18: a shut-off device in accordance with FIG. 14 during the shut-off process;

FIG. 19: a sixth embodiment of a shut-off device in the shut-off position.

### DETAILED DESCRIPTION OF THE FIGURES

The Figures show a waste-water inspection chamber 1 which has an upwardly open gutter 2 with an inlet 3 and an outlet 4 for the waster-water flow in its interior, with the inflow 3 projecting into the interior space of the control chamber 1.

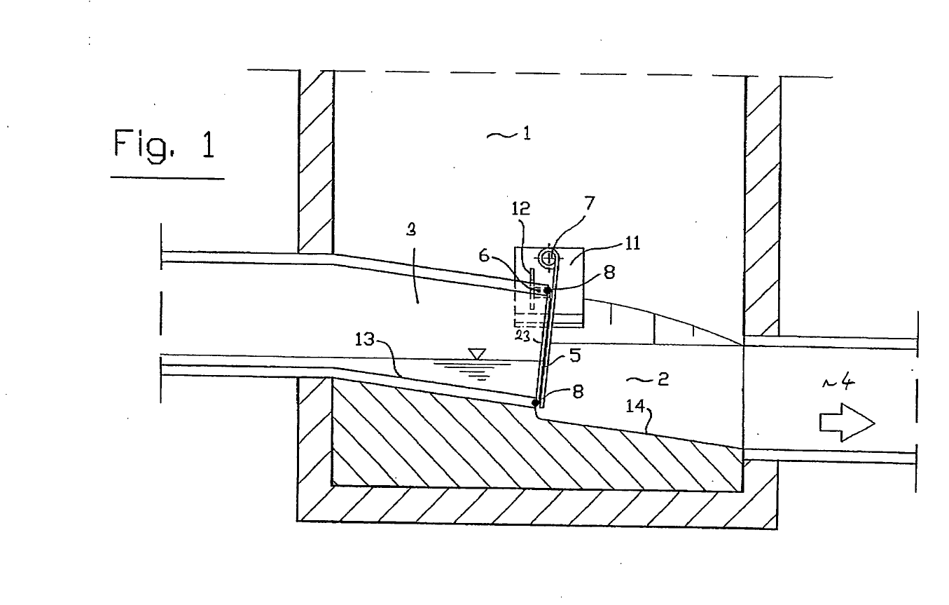

In the first embodiment of the shut-off devices, as shown in FIG. 1, a flap-shaped shut-off member 5 is arranged in front of the inlet opening 23 and can be swung upwardly in the flow direction around a horizontal axis of rotation 7. The axis of rotation 7 is supported in a console 11 which is fastened to the inspection chamber 1. A tab 12 is attached to the console 11 and the magnetic part of the magnetic catch 6 is fastened thereto.

In accordance with the embodiment, the shut-off member 5 is preferably made of metal and thus equally forms the anti-pole reacting to magnetic attractive force.

An annular sealing member 8 is, for example, fastened to the front side of the passage wall of the inlet opening 23 and the shut-off member 5 is sealingly pressed against it by the magnetic attractive force of the magnetic catch 6 in the shut-off position.

The channel base 13 of the inlet 3 is inclined behind the shut-off member 5 in the manner of a ramp in front of the shut-off member 5 and the gutter base 14 seen in the flow direction.

In the region of the shut-off member 5, the gutter 2 has a widened cross-section toward the inlet opening 23 so that the shut-off member 5 is freely pivotable inside the flow cross-section of the gutter 2.

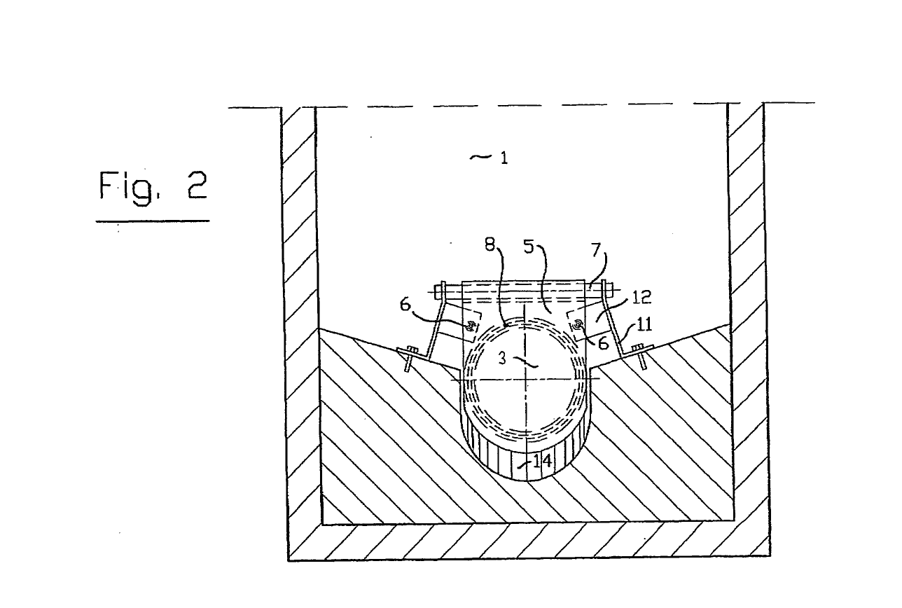

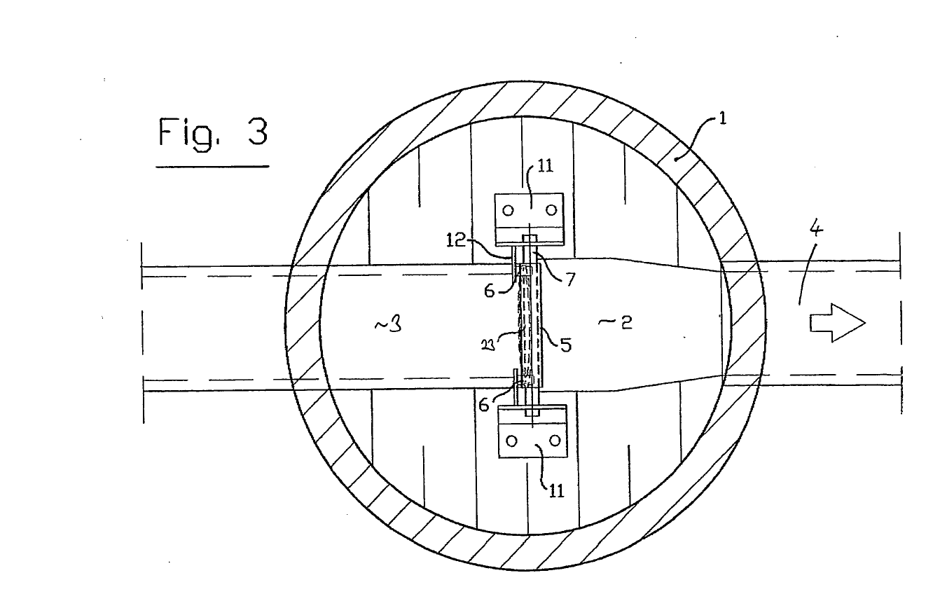

FIGS. 1 to 3 show the shut-off device with the shut-off member 5 held sealingly tight by the magnetic catch 6 in the shut-off position.

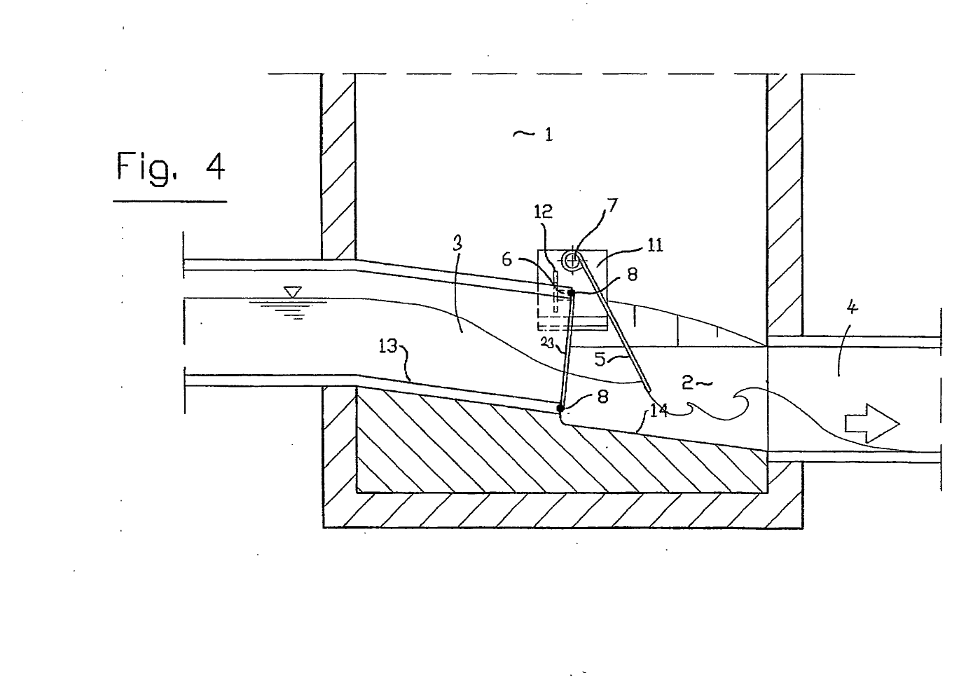

FIG. 4 shows the shut-off member 5 with the shut-off member 5 swung upwardly by the flow force of the drainage surge with a simultaneously released inlet opening 3.

In second to fourth embodiments, a resilient outflow stub 10 is arranged in the interior of the inlet 3 in accordance with the invention and its upper end is sealingly connected to the wall of the inlet 3. The resilient part of the outflow stub 10 directed toward the shut-off member 5 is loosely guided in the inlet 3.

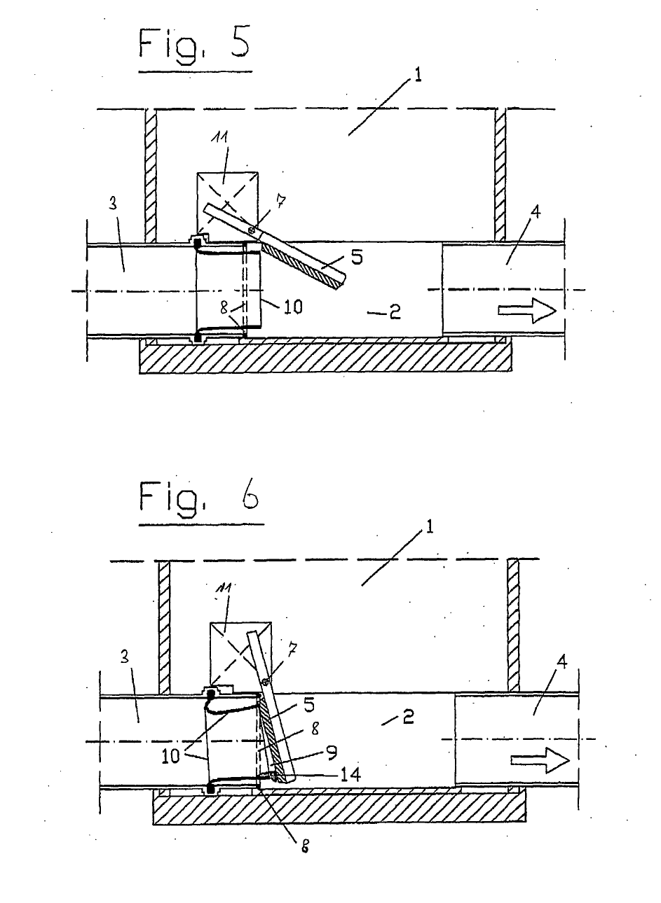

The representation of the magnetic catch was omitted in FIGS. 5 to 10. However, as in the first embodiment, it can comprise a magnetic part attached to the console 11 and a counter-element arranged at the shut-off member 5.

FIG. 5 shows the shut-off member 5 of the second embodiment swung upwardly through the water pressure force of the waste-water flow, with the outflow support 10 extending in its basic shape in the direction of the shut-off member 5 beyond the seal 8.

FIG. 6 shows the shut-off member 5 moving toward the shut-off position with a diminishing waste-water flow. Due to the association of the outflow stub 10, the inlet 3 and the shut-off member 5, the shut-off member 5 first presses against the lower end of the outflow stub 10 and forms an outlet opening 9 which narrows increasingly and at which, by way of example, a solid lump 14 carried along in the waste-water is held back and jammed. As a result of this effect, in accordance with the invention, the solid lump 14 is kept away from the seal 8 surrounding the outflow stub 10.

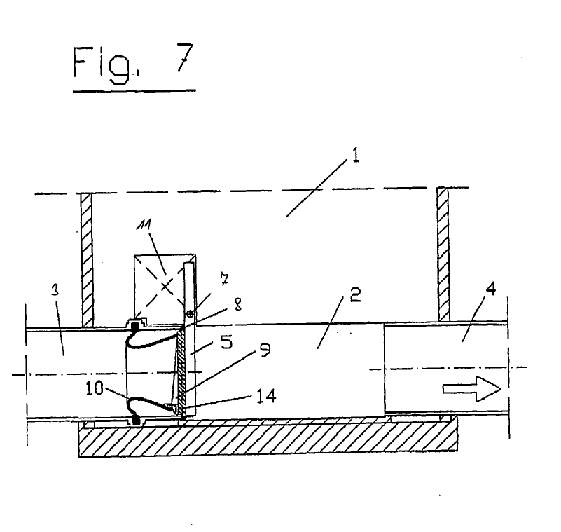

In accordance with FIG. 7, the held back solid lump 14 is preferably pushed into the interior of the inlet 3 as a result of the resiliently deformable outflow stub 10 via the shut-off member 5 which moves further up to the shut-off position without a wedge effect which arises at the wall of the inlet 3 by the jammed solid lump 14 and which could block the movement of the shut-off member 5 into the shut-off position

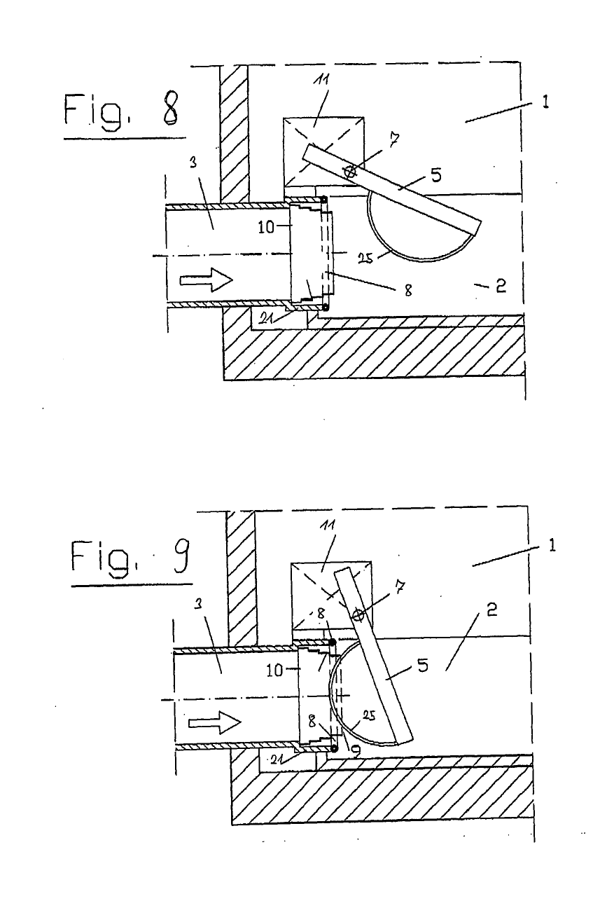

FIGS. 8 to 10 show, as a third embodiment, further developments in accordance with the features listed in the dependent claims analog to FIGS. 5 to 7.

The inlet 3 thus has an expanded cross-section 21 by which the flow cross-section of the outflow stub 10 can be increased and/or a corresponding spacing between the outflow stub 10 and the seal 8 can be effected.

The contour 25 of the shut-off member 5 directed toward the inlet 3 is made convex, whereby the jammed solids are pushed correspondingly far away from the seal 8 up to the shut-off position.

Other contours directed to the interior of the inlet 3 are also conceivable instead of the convexly spherical contour 25.

The resilient outflow stub 10 has a flow cross-section tapering conically in the flow direction.

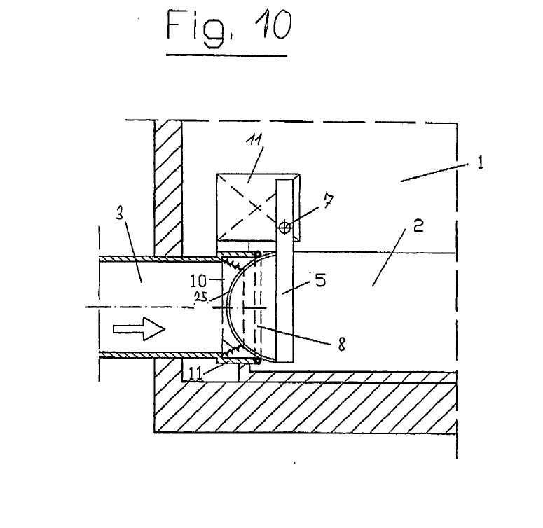

FIG. 11 shows a fourth embodiment of the shut-off device in accordance with the invention with a released inlet. A resilient outflow stub 10 is arranged in the interior of the inlet 3 and its upper end is sealingly connected to the wall of the inlet 3. The resilient part of the outflow stub 10 directed toward the shut-off member 5 is loosely guided in the inlet 3 and projects slightly beyond the inlet opening 23 of the inlet.

The seal 8 in this embodiment is arranged at the outer rim of the shut-off member 5 and comes into contact with the inlet opening 23 in a closed position. The side of the shut-off member 5 facing the inlet 3 has a step 29, with the diameter of the shut-off member 5 being smaller in front of the step 29 than the diameter of the outlet opening 9 of the outflow stub 10 and being larger behind the step 29.

The shut-off member 5 is arranged via a strut 33 at a pivot arm 35 which is rotatably supported around an axis of rotation 7 at the console 11. The magnetic catch comprises a magnetic part 6 at the console and a counter-member 32 at the upper side of the pivot arm 35.

To improve the blocking process of the shut-off device, a housing in which a ball 30 running on a plane 31 is located is integrated into the pivot arm 35. In the position of the pivot lever 35 shown in FIG. 11, this plane 31 extends obliquely to the bottom left so that the ball is located at the far left on the plane 31 and is in contact with a left hand side wall of the housing. The pivot arm 35 with the shut-off member 5 is, however, balanced such that the side of the pivot arm 35 with the shut-off member 5 overbalances and moves the pivot arm 35 clockwise if no liquid flow, or only a low liquid flow, flows out of the inlet 3.

The housing with the ball 30 arranged at the pivot arm 35 hereby also in particular rotates. At that moment at which the plane 31 faces slightly to the bottom right, the ball 30 start to roll down the plane 31 to the right and thus accelerates the closing movement of the shut-off member 5. The shut-off device is reliably closed by this acceleration and the additional impact of the ball 30 against the right hand side of the housing.

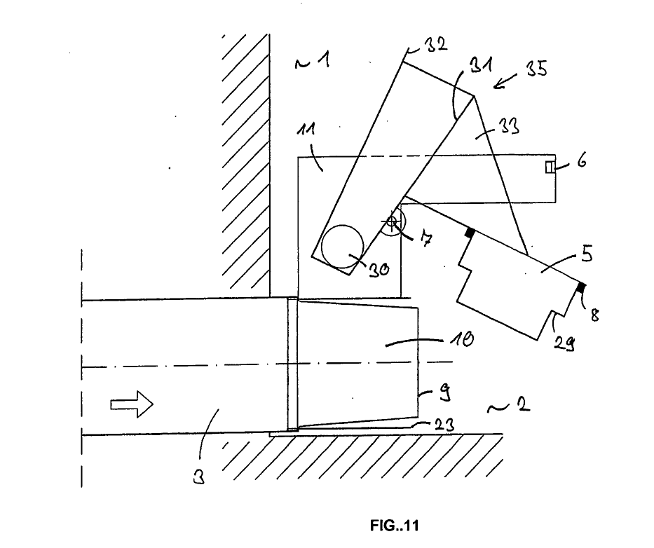

In FIG. 12, the shut-off device is now shown in the shut-off position. The ball 30 is located at the far right in the housing. The counter elements 32 are in contact with the magnetic element 6 so that the magnetic catch holds the shut-off device closed up to a predetermined value against the pressure exerted by the water backing up in the inlet 3.

The step 29 of the shut-off member 5 is in contact with the resilient outflow stub 10 at its outlet opening 9 and thus presses the outflow stub 10 together like a bellows. A step hereby arises in the inlet 3 and keeps dirt away from the seal 8 which now seals the inlet opening 23 against the shut-off member 5.

If a certain quantity of water has collected in the inlet 3, the magnetic catch 6 releases again and releases the inlet. The ball thus accelerates the opening process from a certain point again and thus ensures that the inlet opening 23 remains free longer. The motion procedure on the opening and closing can thus be optimized by a skillful balancing of the pivot arm.

FIG. 13 shows the fourth embodiment in the closed position in a sectional view. The magnetic part 6 of the magnetic catch is made adjustable here so that the force with which the magnetic catch holds the shut-off member in the closed position is freely selectable. The pressure and thus the backed up quantity of water can thus be set at which the shut-off device opens and initiates the flushing procedure.

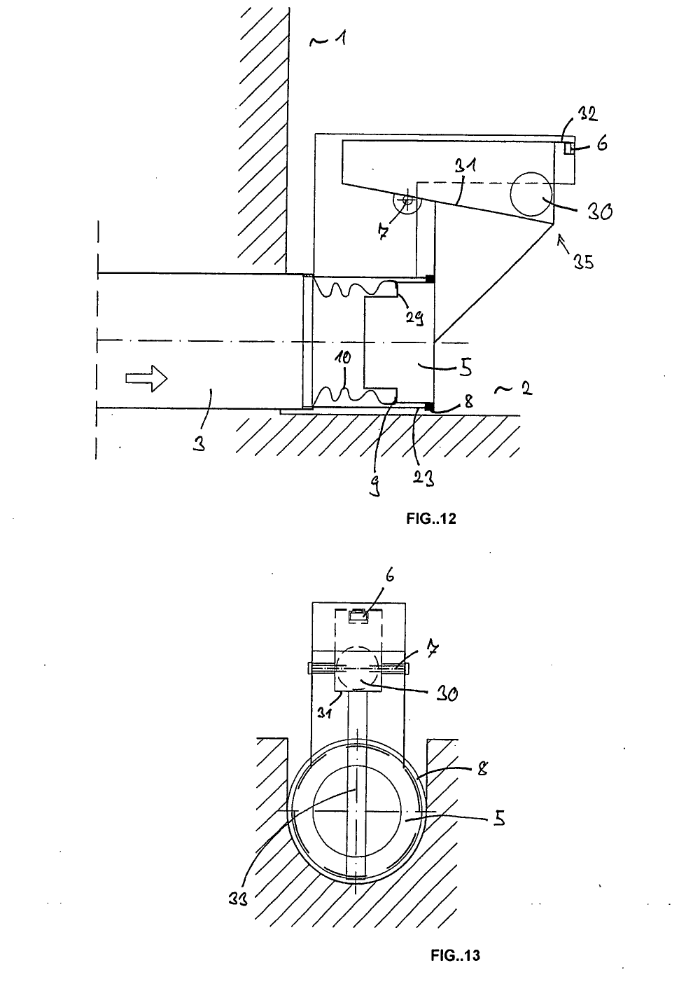

FIG. 14 shows a further embodiment of the shut-off device of the present invention which in turn includes the pivot arm 35 with the ball 30 of the fourth embodiment running on a plane 31, wherein, however, instead of the resilient outflow stub used there, a rake part 40 is used to prevent particularly bulky and lumpy solids from being able to be jammed between the shut-off member 5 with the seal 8 and the inlet opening 23 of the inlet 3. The rake part 40 is arranged pivotably around an axis 41 in the region of the pipe limb in the inlet 3 at a defined spacing in front of the shut-off member 5 and has substantially the same height as the inlet 3.

The seal 8 is in turn arranged at the outer rim of the shut-off member 5 and comes into contact with the inlet opening 23 in the closed position. The contour 25 of the side of the shut-off member 5 facing the inlet 3 projects into the inlet opening 23.

FIG. 15 shows a section through the inlet 3 at the level of the rake part 40. The latter is pivotably arranged around the axis 41 in the apex region of the inlet 3, with the lower edge of the rake part 40 being almost in contact with the base of the inlet in the hanging position shown here.

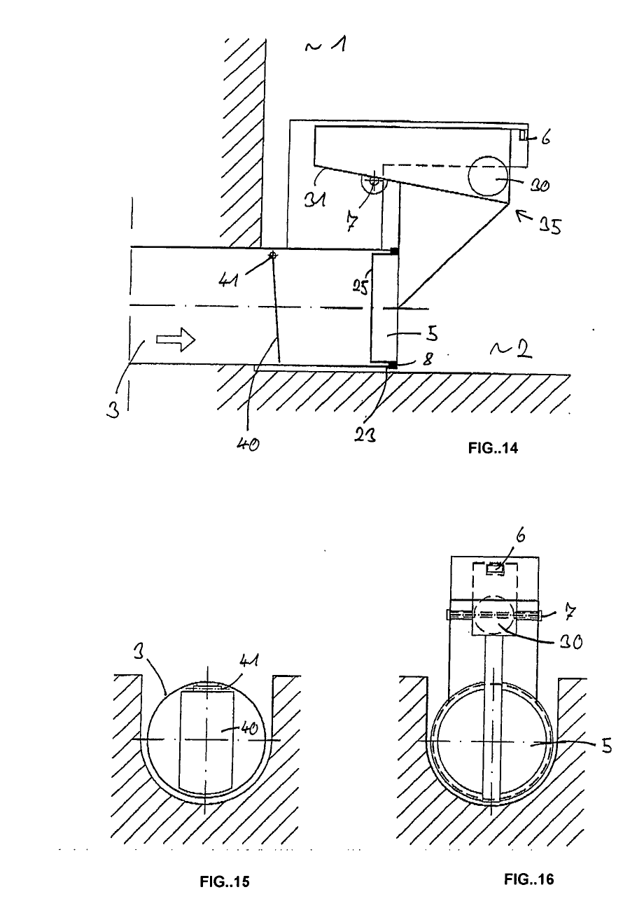

FIG. 16 shows a sectional view of the embodiment at the level of the shut-off member 5 which substantially corresponds to the sectional view of the fourth embodiment shown in FIG. 13.

FIG. 17 now shows the fifth embodiment of the present invention during the flushing process. The pressure by the backed up water in the inlet 3 has opened the magnetic catch 6 so that the shut-off member 5 has been moved out of its shut-off position by the water flow and the total pivot arm 35 has been rotated with the shut-off member 5 counterclockwise around the axis of rotation 7. The inlet opening 23 is thus released, the water flows at high speed into the gutter 2. The rake part 40 is likewise rotated counterclockwise upwardly in the direction of the inlet opening 23 by the flow of the water around the axis 41. The water can flow out of the inlet without impediment, with bulky or lumpy solids which are carried along being carried along by the strong flow of the water.

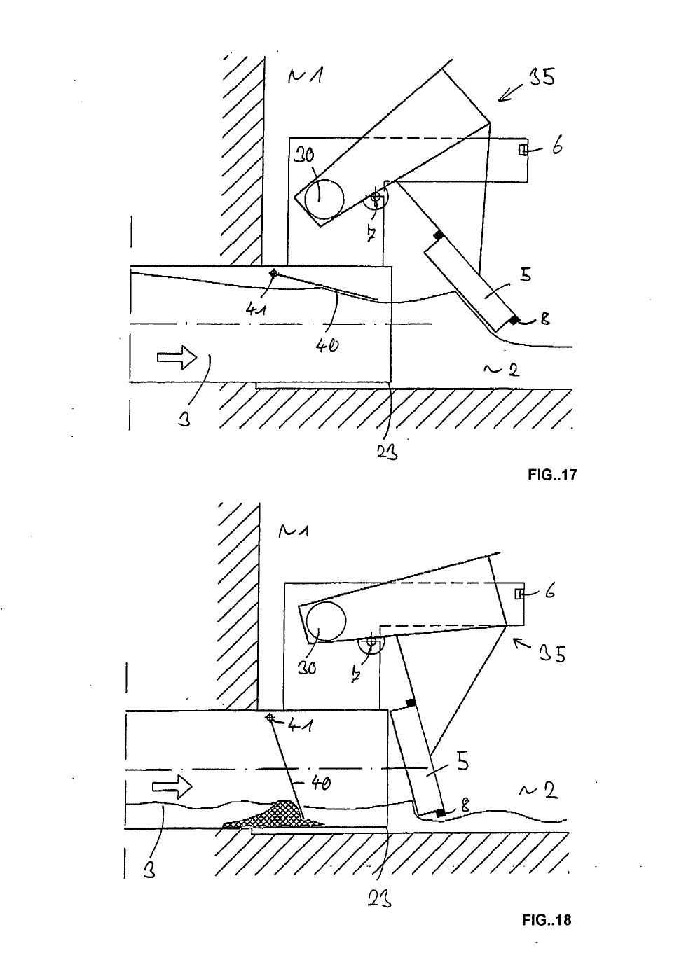

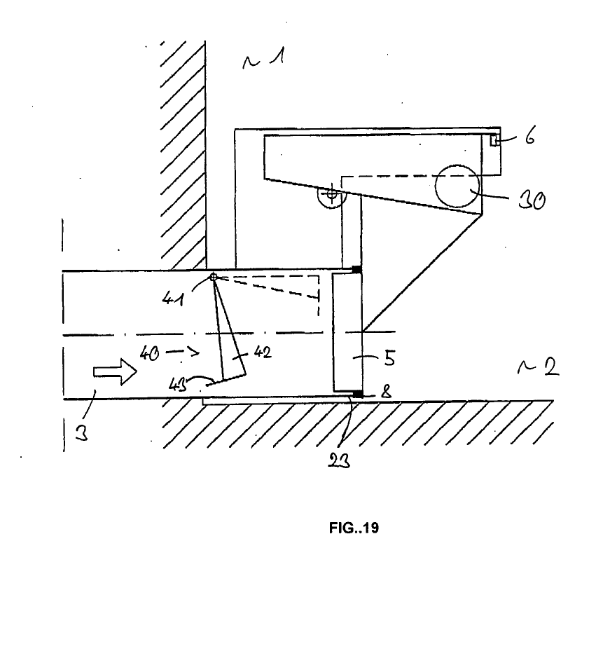

FIG. 18 now shows the fifth embodiment during the closing process of the shut-off member 5. The water flow out of the inlet 3 has diminished greatly so that the shut-off member 5 is no longer pushed upwardly so much by the flow. The pivot arm 35 with the shut-off member 5 has hereby again rotated clockwise around the axis of rotation 7 so that the spacing between the seal 8 of the shut-off member 5 and the inlet opening 23 has become lower.

The flow is now also no longer so strong that bulky or lumpy solids would be carried along so that there would be a risk that they would be jammed between the shut-off member 5 and the inlet opening 23, whereby the shut-off member 5 would no longer completely close the inlet 3. This is, however, prevented by the rake part 40 which is likewise no longer upwardly rotated by the flow, but rather substantially hangs down. It hereby acts like a type of pre-barrier which still holds back bulky and lumpy solids before the inlet opening 23 so that the shut-off member 5 can reliably close the inlet 3. As already described in the fourth embodiment, the ball 30, which rolls to the right on a further rotation of the rotary arm 35, provides an additional acceleration at the end of the closing procedure and thus a reliable blocking of the inlet 3 by the shut-off member 5.

FIG. 19 shows a sixth embodiment of the present invention which only differs from the fifth embodiment in the design of the rake part (40). The rake part (40) of the sixth embodiment includes a float member (42) which is integrated into the rake part (40) and in particular ensures buoyancy in the lower region of the rake part (40) when water backs up in the inlet (3) and the water level thus rises. As shown by dashed lines, the rake part in the backed up water is hereby moved upwardly since the rake part floats upwardly due to the buoyancy generated by the float member (42) in particular in the lower part of the rake part in contact with the water.

The solids held by the rake part are hereby released and can be flushed away without hindrance in the next flush cycle. If, however, the water level falls again on a diminishing of the water flow, the rake part (40) again moves into its substantially perpendicular position and acts as a pre-barrier.

The transverse part (43) attached on the side facing away from the shut-off member (5) at the bottom on the rake part (40) provides an even better retention of the solids since it extends substantially parallel to the channel base of the inlet (3) in the pre-barrier position and thus applies a greater resistance to the solids. As the water level increases after the shutting off of the inlet (3), the transverse part (43) comes into a substantially vertical position due to the movement of the rake part (40) so that any solids possibly adhering to the transverse part (42) release from it again.

1. A shut-off device for a waste-water inspection chamber which has an upwardly open gutter having an inlet opening and an outlet opening for the waste-water flow in its interior, comprising:
a shut-off member which is arranged in front of the inlet opening, and which can be swung upwardly through a flow force of the waste-water flow and can be held and released by a magnetic catch, where the magnetic catch sealingly holds the shut-off member in the shut-off position against the inlet opening and releases it on a defined water pressure acting on it in the flow direction for the release of the inlet opening.

2. A shut-off device in accordance with claim 1, wherein the magnetic catch is arranged outside a flow cross-section.

3. A shut-off device in accordance with claim 1, wherein the magnetic catch is adjustable in its position for the varying of a closing force.

4. A shut-off device in accordance with claim 1, wherein a front side of the inlet opening is provided with a sealing member.

5. A shut-off device in accordance with claim 1, wherein the shut-off device is configured to be introduced into the inspection chamber via a guide from above, locked and removed again.

6. A shut-off device in accordance with claim 1, wherein a resilient outflow stub is arranged in an interior of the inlet, the resilient outflow stub being directed toward the shut-off member for the waste-water flow and forming a narrowing outlet opening with its end directed toward the shut-off member in conjunction with the shut-off member moving toward the shut-off position, with the solids carried along in the waste-water being held back at said outlet opening.

7. A shut-off device in accordance with claim 6, wherein an upper end of the outflow stub, in the flow direction, is fastened to a wall of the inlet; and where a lower end of the outflow stub is loosely guided in the inlet and is resiliently deformable by the shut-off member moving toward the shut-off position.

8. A shut-off device in accordance with claim 7, wherein the lower loose end of the outflow stub projects beyond an end of the inlet with a released inlet opening.

9. A shut-off device in accordance with claim 6, wherein a contour of the shut-off member directed toward the outflow stub or toward the inlet opening is convex or stepped.

10. A shut-off device in accordance with claim 1, wherein a contour of the shut-off member projects into the inlet opening in the shut-off position.

11. A shut-off device in accordance with claim 6, wherein the outflow stub has a flow cross-section tapering conically in the flow direction.

12. A shut-off device in accordance with claim 1, wherein the shut-off member is connected to a pivot arm in a motion-matched manner in that an acceleration member is movable along a guide in a direction perpendicular to an axis of rotation.

13. A shut-off device in accordance with claim 1, further comprising a rake part movable by the waste-water flow arranged in an interior of the inlet at a defined spacing from the shut-off member.

14. A shut-off device in accordance with claim 13, wherein the rake part is hingedly connected in its apex region in the inlet.

15. A shut-off device in accordance with claim 13, wherein the rake part includes a float member.

16. A system, comprising:
a waste-water inspection chamber which has an upwardly open gutter having an inlet opening and an outlet opening for the waste-water flow in its interior; and
a shut-off device, the shut-off device having a shut-off member which is arranged in front of the inlet opening, and which swings upwardly through a flow force of the waste-water flow; and
a magnetic catch that holds and releases the shut-off member, where the magnetic catch sealingly holds the shut-off member in the shut-off position against the inlet opening and releases it on a defined water pressure acting on it in the flow direction for the release of the inlet opening.

17. The system in accordance with claim 16, wherein the magnetic catch is arranged outside a flow cross-section, where the magnetic catch is adjustable in its position for the varying of a closing force, and where a front side of the inlet opening is provided with a sealing member.

18. The system in accordance with claim 17, wherein the shut-off device is configured to be introduced into the inspection chamber via a guide from above, locked and removed again, and, wherein a resilient outflow stub is arranged in an interior of the inlet, the resilient outflow stub being directed toward the shut-off member for the waste-water flow and forming a narrowing outlet opening with its end directed toward the shut-off member in conjunction with the shut-off member moving toward the shut-off position, with the solids carried along in the waste-water being held back at said outlet opening, and wherein an upper end of the outflow stub, in the flow direction, is fastened to a wall of the inlet; and where a lower end of the outflow stub is loosely guided in the inlet and is resiliently deformable by the shut-off member moving toward the shut-off position, and where the lower loose end of the outflow stub projects beyond an end of the inlet with a released inlet opening.

19. A system, comprising:
a waste-water inspection chamber which has an upwardly open gutter having an inlet opening and an outlet opening for the waste-water flow in its interior;
a shut-off device, the shut-off device having a shut-off member which is arranged in front of the inlet opening, and which swings upwardly through a flow force of the waste-water flow; and
a magnetic catch that holds and releases the shut-off member, where the magnetic catch sealingly holds the shut-off member in the shut-off position against the inlet opening and releases it on a defined water pressure acting on it in the flow direction for the release of the inlet opening, wherein the shut-off member is connected to a pivot arm in a motion-matched manner in that an acceleration member is movable along a guide in a direction perpendicular to an axis of rotation; and
a rake part movable by the waste-water flow arranged in an interior of the inlet at a defined spacing from the shut-off member.

20. The system in accordance with claim 19, wherein the rake part is hingedly connected in its apex region in the inlet.
